(19) United States
(12) Patent Application Publication
(10) Pub. No.: US 2025/0140907 A1
(43) Pub. Date: May 1, 2025

(54) LITHIUM ION CONDUCTIVE CERAMIC MATERIAL

(71) Applicant: Gelion Technologies Pty Ltd, North Sydney (AU)

(72) Inventor: Mark Robert Feaviour, Reading (GB)

(73) Assignee: Gelion Technologies Pty Ltd, North Sydney (AU)

(21) Appl. No.: 18/682,809

(22) PCT Filed: Aug. 10, 2022
(86) PCT No.: PCT/GB2022/052089

§ 371 Date: Feb. 9, 2024

(30) Foreign Application Priority Data
Aug. 11, 2021 (GB) 2111533.2

(51) Int. Cl. H01M 10/0562; H01M 10/0525

(52) U.S. Cl. CPC H01M 10/0562; H01M 10/0525; H01M 2300/0071; H01M 2300/008

(57) ABSTRACT

The present invention provides a ceramic material for a solid-state electrolyte, the ceramic material comprising: a first lithium ion conductor; and a second lithium ion conductor different from the first lithium ion conductor and which is a lithium metal halide.

### FIELD OF THE INVENTION

The present invention relates to lithium ion conductive ceramic materials, a solid-state electrolyte and electrochemical cell comprising the ceramic material, and a method of preparing the lithium ion conductive ceramic materials.

### BACKGROUND

Rechargeable lithium ion batteries have many of the desired properties for use in portable electronic applications like mobile phones, tablets, laptops and power tools, and also in electric vehicles. They have good energy densities and can be repeatedly recharged.

Rechargeable lithium ion batteries typically comprise a positive electrode (cathode), negative electrode (anode) and an electrolyte interposed between the cathode and anode. Compared to traditional liquid electrolytes, solid-state electrolytes tend to have improved stability, higher energy density and a longer life, among other benefits. Improved stability is an important factor in providing safer electronic devices and electric vehicles.

Traditional solid-state electrolyte materials include lithium-phosphorus oxynitride (Li_{2.9}PO_{3.3}N_{0.46}), lithium nitride (Li₃N) and Li-β-aluminium oxide. However, these materials tend to have a lower ion conductivity than liquid electrolytes which reduces battery performance. They also tend to be very sensitive to moisture, which makes manufacture difficult and can reduce battery lifetimes. Lithium nitride and Li-β-aluminium oxide are also not chemically stable, so are prone to decomposition.

Alternative ceramic materials such as lithium lanthanum zirconium oxide (LLZO—as described in US 2010/203383), lithium aluminium titanium phosphate (LATP—as described in US 2014/0162136) and lithium yttrium zirconium phosphate (LYZP—as described in US 2019/0067736) have a more appreciable lithium ion conductivity. However, preparing a lithium ion conducting ceramic of these materials is an energy intensive process. First, a powder is formed by a process including a high temperature heat treatment. Second, the powder is sintered under high pressure and temperature over a long period of time, to provide a ceramic material which can be used as a solid-state electrolyte. For example, LLZO powder tends to be sintered at around 1050° C. for 10 hours. Similarly, LATP is sintered at around 900° C.

The high temperature and long period of time required makes the sintering process highly energy intensive and difficult to scale up to a commercially viable level. This increases the cost and environmental impact of manufacture.

These known ceramic materials are also air and moisture sensitive. For example, LLZO tends to absorb water and carbon dioxide to form Li₂CO₃. This leads to a decrease in lithium ion conductivity, especially at the surface of the solid-state electrolyte material, leading to increased interfacial resistance between the electrolyte and electrodes. The decrease in lithium ion conductivity is largely irreversible, without significant additional processing. For example, removing Li₂CO₃ from LLZO may be achieved by heating to 1250° C.

Accordingly, there is a need to provide improved ceramic materials for use as solid-state electrolytes, which are efficient and cheap to manufacture, while achieving high lithium ion conductivity, low interfacial resistance, and a good tolerance to air and moisture.

### SUMMARY OF THE INVENTION

In general, the present inventors have surprisingly found that the addition of a lithium metal halide to a lithium ion conducting material allows for a highly lithium ion conductive ceramic material to be prepared without the need for high temperature sintering. This significantly reduces the energy required for manufacture, thus reducing the cost and the environmental impact of the material. Various other advantages of the ceramic material such as excellent tolerance to air and moisture, and low density are discussed herein.

In a first aspect of the invention there is provided a ceramic material for a solid-state electrolyte, the ceramic material comprising:
a first lithium ion conductor; and
a second lithium ion conductor different from the first lithium ion conductor and which is a lithium metal halide.

Known ceramic materials, such as LLZO, LATP or LYZP, must be sintered at high temperature over a relatively long period of time, to provide a ceramic material having sufficient lithium ion conductivity for use as a solid-state electrolyte. The high temperature required makes the sintering process very energy intensive. However, it has surprisingly been found that adding a lithium metal halide, such as lithium indium chloride (LIC), lithium yttrium zirconium chloride (LYZC) or a lithium gallium fluoride-chloride mixed halide (LGFC), to a lithium ion conductor allows the ceramic material to be prepared under high pressure but at lower temperature than would otherwise be possible, without jeopardising lithium ion conductivity.

Without wishing to be bound by theory, it is thought the softness of the lithium metal halide means that it can act as a “flux” to mobilise particles of a first lithium ion conductor, which may be harder than the lithium metal halide. As a result, the particles are sufficiently mobile for the composite ceramic material to be prepared at room temperature.

The resulting ceramic material exhibits a comparable lithium ion conductivity to materials which have been sintered at much higher temperatures, so performs well as a solid-state electrolyte. Overall, this reduces the energy required, and in turn reduces the cost and environmental impact of preparing the ceramic material. This also makes production easier to scale to a commercially viable level.

The ceramic material also has an advantageously low density. Lithium metal halides tend to have a lower density than other solid-state electrolyte materials such as LLZO or LATP. Therefore, including a portion of lithium metal halide results in a low density ceramic material. Electrochemical cells incorporating the ceramic material as a solid-state electrolyte offer a high gravimetric energy density. This may be a higher gravimetric energy density than, for example, electrochemical cells using a pure LLZO, LATP or LYZP solid-state electrolyte. This is particularly advantageous for portable electronic applications and electric vehicles.

The ceramic material also has excellent air and moisture resistance. Certain lithium metal halides are hygroscopic, and may be more hygroscopic than other solid-state electrolyte materials such as LLZO. Without wishing to bound by theory, it is thought that these lithium metal halides tend to absorb water in preference to other components of the ceramic material. This means that the other components do not absorb as much water, thus mitigating the reduction in lithium ion conductivity and increased interfacial resistance caused by water absorption.

Additionally, the absorption of water into certain lithium metal halides is reversible, compared to the absorption into other solid-state electrolyte materials such as LLZO, LATP or LYZP. Thus, the ceramic material can be regenerated after exposure to air and moisture. Without wishing to be bound by theory, it is thought that by heating to a moderate temperature under vacuum, for example around 200° C., the water is desorbed from the lithium metal halide component of the ceramic material. As the water is predominately absorbed into the lithium metal halide (e.g. LIC), rather than other components, this regenerates the ceramic material and the lithium ion conductivity is substantially restored.

This has the further benefit that the ceramic material may be manufactured in the presence of air and moisture, because the ceramic may be regenerated (for example, as described above) prior to incorporation into a final product. This means the ceramic material may not need to be manufactured under an inert atmosphere. This reduces the cost of manufacture and makes production easier to scale up to a commercially viable level.

A further benefit of a ceramic material comprising a mixture of lithium ion conductors is low material cost. In particular, lithium metal halides are expensive, so a solid-state electrolyte containing only lithium metal halide is not commercially viable. However, it has surprisingly be found that by mixing lithium metal halide with a portion of less expensive lithium ion conductor, the beneficial properties of the lithium metal halide can be retained, while reducing the overall material cost.

The ceramic material also offers improved electrode compatibility, compared to pure lithium metal halide solid-state electrolytes (e.g. LIC) which are largely incompatible with lithium metal electrodes. It is thought that by incorporating the lithium metal halide into a ceramic material including an additional lithium ion conductor, such as LLZO or LATP, the ceramic material has the potential for improved compatibility with lithium metal electrodes in comparison with pure lithium metal halide (e.g. LIC).

In a second aspect of the invention there is provided a method of preparing a ceramic material for a solid-state electrolyte, comprising the following steps:
a) mixing a particulate of a first lithium ion conductor and a particulate of a second lithium ion conductor to form a mixture, wherein the second lithium ion conductor is different to the first lithium ion conductor and is a lithium metal halide;
b) pressing the mixture to form the ceramic material.

The preparation of known ceramic materials, such as LLZO, LATP or LYZP requires them to be sintered under high pressure and temperature over a long period of time, to provide a ceramic material having sufficient lithium ion conductivity for use as a solid-state electrolyte. The high temperature required makes the sintering process very energy intensive. However, it has surprisingly been found that including a mixture of lithium ion conductors, including a lithium metal halide, that the ceramic material can be prepared under high pressure but at room temperature.

Overall, this reduces the energy required, and in turn reduces the cost and environmental impact of the ceramic material. This also makes production easier to scale to a commercially viable level.

The method of preparing the ceramic material is also able to be carried out in the presence of air and moisture, because the ceramic material has excellent tolerance to air and moisture and may be regenerated prior to incorporation into a final product. This means the ceramic material does not need to be manufactured under an inert atmosphere. This reduces the cost of manufacture and makes production easier to scale up to a commercially viable level.

In a third aspect of the invention there is provided a ceramic material obtained or obtainable by the method described in the second aspect of the invention.

In a fourth aspect of the invention there is provided a solid-state electrolyte comprising the ceramic material of the first or third aspects of the invention.

In a fifth aspect of the invention there is provided an electrochemical cell comprising a cathode, an anode, and the solid-state electrolyte according to the fourth aspect of the invention.

### BRIEF DESCRIPTION OF THE DRAWINGS

The present invention is described with reference to the figure below.

FIG. 1 shows a bar chart of the conductivity of the ceramic material of Comparative Example 1 (0 wt. % LIC) and Examples 1-A (5 wt. % LIC), 1-B (10 wt. % LIC), 1-C (15 wt. % LIC), 1-D (20 wt. % LIC), 1-E (25 wt. % LIC) and 1-F (30 wt. % LIC), prepared using pressing methods A and B.

FIG. 2A shows an overlayed Raman spectra of Example 3-A (70:30 Al-LLZO to LYZC) with pure Al-LLZO and LYZC.

FIG. 2B shows an overlayed Raman spectra of Example 3-B (70:30 LATP to LYZC) with pure LATP and LYZC.

FIG. 3A shows a focused ion beam-scanning electron microscopy (FIB-SEM) image of Example 3-A (70:30 Al-LLZO to LYZC).

FIG. 3B shows a focused ion beam-scanning electron microscopy (FIB-SEM) image of Example 3-B (70:30 LATP to LYZC).

### DETAILED DESCRIPTION OF THE INVENTION

### Definitions

The following common definitions are used herein, as determined by the relevant context.

The term “lithium ion conductor” as used herein refers to a solid material which facilitates the flow of lithium ions.

The term “lithium metal halide” as used herein refers to an inorganic material comprising lithium, one or more metals different from lithium, and a halide. The lithium metal halide may comprise a single halide, e.g. Cl, or a mixture of halides, e.g. a combination of Cl and F.

The term “lithium metal oxide” as used herein refers to an inorganic material including lithium, one or more metals different from lithium, and oxygen.

The term “lithium metal phosphate” as used herein refers to an inorganic material including lithium, one or more metals different from lithium, and phosphate

The term “particulate” as used herein refers to a material in the form of separate particles, such as a powder.

The term “pressing” as used herein refers to applying a pressure.

The term “room temperature” as used herein denotes a temperature of about 25° C.

The term “under vacuum” as used herein denotes an absolute pressure of between 0.1 and 30000 Pa, preferably 1 to 10000 Pa, preferably 10 to 5000 Pa, preferably 50 to 2000 Pa, preferably 100 to 1000 Pa, more preferably about 500 Pa.

The term “dry” as used herein denotes a moisture content of less than 10 ppm by weight, preferably less than 5 ppm by weight, more preferably less than 1 ppm by weight.

The term “CO₂ free” as used herein denotes air with a CO₂ content of less than 5 ppm by weight, preferably less than 3 ppm by weight, more preferably less than 1 ppm by weight.

The term “conductivity” as used herein, unless stated otherwise, refers to lithium ion conductivity.

The term “hardness” as used herein refers to hardness measured on the “Moh scale”.

The term “tensile stiffness” denotes the Young's modulus, measured according to ISO 17561.

The term “crystal density” as used herein refers to the mass of solid per unit volume occupied by the material.

The term “bulk density” as used herein refers to the mass of solid per unit of total volume occupied by a powder.

The term “gravimetric energy density” as used herein refers to the energy density per unit mass.

### Ceramic Material

In a first aspect of the invention there is provided a ceramic material for a solid-state electrolyte, the ceramic material comprising:
a first lithium ion conductor; and
a second lithium ion conductor different from the first lithium ion conductor and which is a lithium metal halide.

In some embodiments the ceramic material has a conductivity of from 1×10⁻⁵ to 3×10⁻³ S/cm, preferably from 1×10⁻⁵ to 1×10⁻³ S/cm, preferably from 5×10⁻⁵ to 8×10⁻⁴ S/cm, preferably from 8×10⁻⁵ to 5×10⁻⁴ S/cm, more preferably from 1×10⁻⁴ to 3×10⁻⁴ S/cm. In some embodiments the ceramic material has a conductivity of greater than 1×10⁻⁵ S/cm, preferably greater than 5×10⁻⁵ S/cm, more preferably greater than 1.0×10⁻⁴ S/cm, even more preferably greater than 1.0×10⁻³ S/cm. In some embodiments the ceramic material has a conductivity of about 1.0×10⁻⁴ S/cm. The conductivity is the lithium ion conductivity for a ceramic body of the ceramic material. This conductivity is indicative of an excellent solid-state electrolyte material.

Conductivity is measurable by electrochemical impedance spectroscopy, for example using a Biologic VSP potentiostat, using a pellet of material having a diameter of 8 mm and a thickness between 0.5 and 1 mm, using a 50 mV perturbation voltage applied in the frequency range of 1 MHz to 0.1 mHz, at a temperature of 25° C.

In some embodiments the first lithium ion conductor is lithium lanthanum zirconium oxide and the second lithium ion conductor is lithium indium chloride.

In some embodiments the first lithium ion conductor is aluminium doped lithium lanthanum zirconium oxide and the second lithium ion conductor is lithium indium chloride.

In some embodiments the first lithium ion conductor is tantalum doped lithium lanthanum zirconium oxide and the second lithium ion conductor is lithium indium chloride.

In some embodiments the first lithium ion conductor is lithium lanthanum zirconium oxide and the second lithium ion conductor is lithium yttrium zirconium chloride.

In some embodiments the first lithium ion conductor is aluminium doped lithium lanthanum zirconium oxide and the second lithium ion conductor is lithium yttrium zirconium chloride.

In some embodiments the first lithium ion conductor is tantalum doped lithium lanthanum zirconium oxide and the second lithium ion conductor is lithium yttrium zirconium chloride.

In some embodiments the first lithium ion conductor is lithium lanthanum zirconium oxide and the second lithium ion conductor is a lithium gallium fluoride-chloride mixed halide.

In some embodiments the first lithium ion conductor is aluminium doped lithium lanthanum zirconium oxide and the second lithium ion conductor is a lithium gallium fluoride-chloride mixed halide.

In some embodiments the first lithium ion conductor is tantalum doped lithium lanthanum zirconium oxide and the second lithium ion conductor is a lithium gallium fluoride-chloride mixed halide.

In some embodiments the first lithium ion conductor is lithium aluminium titanium phosphate and the second lithium ion conductor is lithium yttrium zirconium chloride.

In some embodiments the first lithium ion conductor is lithium aluminium titanium phosphate and the second lithium ion conductor is lithium indium chloride.

In some embodiments the first lithium ion conductor is lithium aluminium titanium phosphate and the second lithium ion conductor is a lithium gallium fluoride-chloride mixed halide.

In some embodiments the first lithium ion conductor is lithium yttrium zirconium phosphate and the second lithium ion conductor is lithium yttrium zirconium chloride.

In some embodiments the first lithium ion conductor is lithium yttrium zirconium phosphate and the second lithium ion conductor is lithium indium chloride.

In some embodiments the first lithium ion conductor is lithium yttrium zirconium phosphate and the second lithium ion conductor is a lithium gallium fluoride-chloride mixed halide.

In some embodiments the ceramic material comprises a first lithium ion conductor, a second lithium ion conductor and optionally other components.

In some embodiments the ceramic material comprises 50 to 99 wt. % of the first lithium ion conductor, preferably 60 to 90 wt. %, preferably 65 to 80 wt. %, more preferably 68 to 75 wt. %. In some embodiments the ceramic material comprises about 70 wt. % of the first lithium ion conductor.

In some embodiments the ceramic material comprises 1 to 50 wt. % of the second lithium ion conductor, preferably 10 to 40 wt. %, preferably 20 to 35 wt. %, more preferably 25 to 32 wt. %. In some embodiments the ceramic material comprises about 30 wt. % of the second lithium ion conductor.

In some embodiments the ceramic material comprises 50 to 99 wt. % of the first lithium ion conductor and 1 to 50 wt. % of the second lithium ion conductor, preferably 60 to 90 wt. % of the first lithium ion conductor and 10 to 40 wt. % of the second lithium ion conductor, preferably 65 to 80 wt. % of the first lithium ion conductor and 20 to 35 wt. % of the second lithium ion conductor, more preferably 68 to 75 wt. % of the first lithium ion conductor and 25 to 32 wt. % of the second lithium ion conductor. In some embodiments the ceramic material comprises about 70 wt. % of the first lithium ion conductor and about 30 wt. % of the second lithium ion conductor.

In some embodiments the ceramic material comprises 50 to 99 wt. % lithium lanthanum zirconium oxide and 1 to 50 wt. % lithium indium chloride, preferably 60 to 90 wt. % lithium lanthanum zirconium oxide and 10 to 40 wt. % lithium indium chloride, preferably 65 to 80 wt. % lithium lanthanum zirconium oxide and 20 to 35 wt. % lithium indium chloride, more preferably 68 to 75 wt. % of lithium lanthanum zirconium oxide and 25 to 32 wt. % of lithium indium chloride. In some embodiments the ceramic material comprises about 70 wt. % lithium lanthanum zirconium oxide and 30 wt. % lithium indium chloride.

In some embodiments the ceramic material comprises 50 to 99 wt. % aluminium doped lithium lanthanum zirconium oxide and 1 to 50 wt. % lithium indium chloride, preferably 60 to 90 wt. % aluminium doped lithium lanthanum zirconium oxide and 10 to 40 wt. % lithium indium chloride, preferably 65 to 80 wt. % aluminium doped lithium lanthanum zirconium oxide and 20 to 35 wt. % lithium indium chloride, more preferably 68 to 75 wt. % aluminium doped lithium lanthanum zirconium oxide and 25 to 32 wt. % lithium indium chloride. In some embodiments the ceramic material comprises about 70 wt. % aluminium doped lithium lanthanum zirconium oxide and 30 wt. % lithium indium chloride.

In some embodiments the ceramic material comprises 50 to 99 wt. % tantalum doped lithium lanthanum zirconium oxide and 1 to 50 wt. % lithium indium chloride, preferably 60 to 90 wt. % tantalum doped lithium lanthanum zirconium oxide and 10 to 40 wt. % lithium indium chloride, preferably 65 to 80 wt. % tantalum doped lithium lanthanum zirconium oxide and 20 to 35 wt. % lithium indium chloride, more preferably 68 to 75 wt. % tantalum doped lithium lanthanum zirconium oxide and 25 to 32 wt. % lithium indium chloride. In some embodiments the ceramic material comprises about 70 wt. % tantalum doped lithium lanthanum zirconium oxide and 30 wt. % lithium indium chloride.

In some embodiments the ceramic material comprises 50 to 99 wt. % lithium lanthanum zirconium oxide and 1 to 50 wt. % lithium yttrium zirconium chloride, preferably 60 to 90 wt. % lithium lanthanum zirconium oxide and 10 to 40 wt. % lithium yttrium zirconium chloride, preferably 65 to 80 wt. % lithium lanthanum zirconium oxide and 20 to 35 wt. % lithium yttrium zirconium chloride, more preferably 68 to 75 wt. % lithium lanthanum zirconium oxide and 25 to 32 wt. % lithium yttrium zirconium chloride. In some embodiments the ceramic material comprises about 70 wt. % lithium lanthanum zirconium oxide and 30 wt. % lithium yttrium zirconium chloride.

In some embodiments the ceramic material comprises 50 to 99 wt. % aluminium doped lithium lanthanum zirconium oxide and 1 to 50 wt. % lithium yttrium zirconium chloride, preferably 60 to 90 wt. % aluminium doped lithium lanthanum zirconium oxide and 10 to 40 wt. % lithium yttrium zirconium chloride, preferably 65 to 80 wt. % aluminium doped lithium lanthanum zirconium oxide and 20 to 35 wt. % lithium yttrium zirconium chloride, more preferably 68 to 75 wt. % aluminium doped lithium lanthanum zirconium oxide and 25 to 32 wt. % lithium yttrium zirconium chloride. In some embodiments the ceramic material comprises about 70 wt. % aluminium doped lithium lanthanum zirconium oxide and 30 wt. % lithium yttrium zirconium chloride.

In some embodiments the ceramic material comprises 50 to 99 wt. % tantalum doped lithium lanthanum zirconium oxide and 1 to 50 wt. % lithium yttrium zirconium chloride, preferably 60 to 90 wt. % tantalum doped lithium lanthanum zirconium oxide and 10 to 40 wt. % lithium yttrium zirconium chloride, preferably 65 to 80 wt. % tantalum doped lithium lanthanum zirconium oxide and 20 to 35 wt. % lithium yttrium zirconium chloride, more preferably 68 to 75 wt. % tantalum doped lithium lanthanum zirconium oxide and 25 to 32 wt. % lithium yttrium zirconium chloride. In some embodiments the ceramic material comprises about 70 wt. % tantalum doped lithium lanthanum zirconium oxide and 30 wt. % lithium yttrium zirconium chloride.

In some embodiments the ceramic material comprises 50 to 99 wt. % lithium lanthanum zirconium oxide and 1 to 50 wt. % a lithium gallium fluoride-chloride mixed halide, preferably 60 to 90 wt. % lithium lanthanum zirconium oxide and 10 to 40 wt. % a lithium gallium fluoride-chloride mixed halide, preferably 65 to 80 wt. % lithium lanthanum zirconium oxide and 20 to 35 wt. % a lithium gallium fluoride-chloride mixed halide, more preferably 68 to 75 wt. % of lithium lanthanum zirconium oxide and 25 to 32 wt. % of a lithium gallium fluoride-chloride mixed halide. In some embodiments the ceramic material comprises about 70 wt. % lithium lanthanum zirconium oxide and 30 wt. % a lithium gallium fluoride-chloride mixed halide.

In some embodiments the ceramic material comprises 50 to 99 wt. % aluminium doped lithium lanthanum zirconium oxide and 1 to 50 wt. % a lithium gallium fluoride-chloride mixed halide, preferably 60 to 90 wt. % aluminium doped lithium lanthanum zirconium oxide and 10 to 40 wt. % a lithium gallium fluoride-chloride mixed halide, preferably 65 to 80 wt. % aluminium doped lithium lanthanum zirconium oxide and 20 to 35 wt. % a lithium gallium fluoride-chloride mixed halide, more preferably 68 to 75 wt. % aluminium doped lithium lanthanum zirconium oxide and 25 to 32 wt. % a lithium gallium fluoride-chloride mixed halide. In some embodiments the ceramic material comprises about 70 wt. % aluminium doped lithium lanthanum zirconium oxide and 30 wt. % a lithium gallium fluoride-chloride mixed halide.

In some embodiments the ceramic material comprises 50 to 99 wt. % tantalum doped lithium lanthanum zirconium oxide and 1 to 50 wt. % a lithium gallium fluoride-chloride mixed halide, preferably 60 to 90 wt. % tantalum doped lithium lanthanum zirconium oxide and 10 to 40 wt. % a lithium gallium fluoride-chloride mixed halide, preferably 65 to 80 wt. % tantalum doped lithium lanthanum zirconium oxide and 20 to 35 wt. % a lithium gallium fluoride-chloride mixed halide, more preferably 68 to 75 wt. % tantalum doped lithium lanthanum zirconium oxide and 25 to 32 wt. % a lithium gallium fluoride-chloride mixed halide. In some embodiments the ceramic material comprises about 70 wt. % tantalum doped lithium lanthanum zirconium oxide and 30 wt. % a lithium gallium fluoride-chloride mixed halide.

In some embodiments the ceramic material comprises 50 to 99 wt. % lithium aluminium titanium phosphate and 1 to 50 wt. % lithium yttrium zirconium chloride, preferably 60 to 90 wt. % lithium aluminium titanium phosphate and 10 to 40 wt. % lithium yttrium zirconium chloride, preferably 65 to 80 wt. % lithium aluminium titanium phosphate and 20 to 35 wt. % lithium yttrium zirconium chloride, more preferably 68 to 75 wt. % lithium aluminium titanium phosphate and 25 to 32 wt. % lithium yttrium zirconium chloride. In some embodiments the ceramic material comprises about 70 wt. % lithium aluminium titanium phosphate and 30 wt. % lithium yttrium zirconium chloride.

In some embodiments the ceramic material comprises 50 to 99 wt. % lithium aluminium titanium phosphate and 1 to 50 wt. % lithium indium chloride, preferably 60 to 90 wt. % lithium aluminium titanium phosphate and 10 to 40 wt. % lithium indium chloride, preferably 65 to 80 wt. % lithium aluminium titanium phosphate and 20 to 35 wt. % lithium indium chloride, more preferably 68 to 75 wt. % lithium aluminium titanium phosphate and 25 to 32 wt. % lithium indium chloride. In some embodiments the ceramic material comprises about 70 wt. % lithium aluminium titanium phosphate and 30 wt. % lithium indium chloride.

In some embodiments the ceramic material comprises 50 to 99 wt. % lithium aluminium titanium phosphate and 1 to 50 wt. % a lithium gallium fluoride-chloride mixed halide, preferably 60 to 90 wt. % lithium aluminium titanium phosphate and 10 to 40 wt. % a lithium gallium fluoride-chloride mixed halide, preferably 65 to 80 wt. % lithium aluminium titanium phosphate and 20 to 35 wt. % a lithium gallium fluoride-chloride mixed halide, more preferably 68 to 75 wt. % lithium aluminium titanium phosphate and 25 to 32 wt. % a lithium gallium fluoride-chloride mixed halide. In some embodiments the ceramic material comprises about 70 wt. % lithium aluminium titanium phosphate and 30 wt. % a lithium gallium fluoride-chloride mixed halide.

In some embodiments the ceramic material comprises 50 to 99 wt. % lithium yttrium zirconium phosphate and 1 to 50 wt. % lithium yttrium zirconium chloride, preferably 60 to 90 wt. % lithium yttrium zirconium phosphate and 10 to 40 wt. % lithium yttrium zirconium chloride, preferably 65 to 80 wt. % lithium yttrium zirconium phosphate and 20 to 35 wt. % lithium yttrium zirconium chloride, more preferably 68 to 75 wt. % lithium yttrium zirconium phosphate and 25 to 32 wt. % lithium yttrium zirconium chloride. In some embodiments the ceramic material comprises about 70 wt. % lithium yttrium zirconium phosphate and 30 wt. % lithium yttrium zirconium chloride.

In some embodiments the ceramic material comprises 50 to 99 wt. % lithium yttrium zirconium phosphate and 1 to 50 wt. % lithium indium chloride, preferably 60 to 90 wt. % lithium yttrium zirconium phosphate and 10 to 40 wt. % lithium indium chloride, preferably 65 to 80 wt. % lithium yttrium zirconium phosphate and 20 to 35 wt. % lithium indium chloride, more preferably 68 to 75 wt. % lithium yttrium zirconium phosphate and 25 to 32 wt. % lithium indium chloride. In some embodiments the ceramic material comprises about 70 wt. % lithium yttrium zirconium phosphate and 30 wt. % lithium indium chloride.

In some embodiments the ceramic material comprises 50 to 99 wt. % lithium yttrium zirconium phosphate and 1 to 50 wt. % a lithium gallium fluoride-chloride mixed halide, preferably 60 to 90 wt. % lithium yttrium zirconium phosphate and 10 to 40 wt. % a lithium gallium fluoride-chloride mixed halide, preferably 65 to 80 wt. % lithium yttrium zirconium phosphate and 20 to 35 wt. % a lithium gallium fluoride-chloride mixed halide, more preferably 68 to 75 wt. % lithium yttrium zirconium phosphate and 25 to 32 wt. % a lithium gallium fluoride-chloride mixed halide. In some embodiments the ceramic material comprises about 70 wt. % lithium yttrium zirconium phosphate and 30 wt. % a lithium gallium fluoride-chloride mixed halide.

In some embodiments the ceramic material substantially consists of a first lithium ion conductor and a second lithium ion conductor. In some embodiments the ceramic material consists of a first lithium ion conductor and a second lithium ion conductor.

In some embodiments the ceramic material consists of 50 to 99 wt. % of the first lithium ion conductor, preferably 60 to 90 wt. %, more preferably 65 to 75 wt. %. In some embodiments the ceramic material consists of about 70 wt. % of the first lithium ion conductor.

In some embodiments the ceramic material consists of 1 to 50 wt. % of the second lithium ion conductor, preferably 10 to 40 wt. %, more preferably 25 to 35 wt. %. In some embodiments the ceramic material consists of about 30 wt. % of the second lithium ion conductor.

In some embodiments the ceramic material consists of 50 to 99 wt. % of the first lithium ion conductor and 1 to 50 wt. % of the second lithium ion conductor, preferably 60 to 90 wt. % of the first lithium ion conductor and 10 to 40 wt. % of the second lithium ion conductor, preferably 65 to 80 wt. % of the first lithium ion conductor and 20 to 35 wt. % of the second lithium ion conductor, more preferably 68 to 75 wt. % of the first lithium ion conductor and 25 to 32 wt. % of the second lithium ion conductor. In some embodiments the ceramic material consists of about 70 wt. % of the first lithium ion conductor and about 30 wt. % of the second lithium ion conductor.

In some embodiments the ceramic material consists of 50 to 99 wt. % lithium lanthanum zirconium oxide and 1 to 50 wt. % lithium indium chloride, preferably 60 to 90 wt. % lithium lanthanum zirconium oxide and 10 to 40 wt. % lithium indium chloride, preferably 65 to 80 wt. % lithium lanthanum zirconium oxide and 20 to 35 wt. % lithium indium chloride, more preferably 68 to 75 wt. % of lithium lanthanum zirconium oxide and 25 to 32 wt. % of lithium indium chloride. In some embodiments the ceramic material consists of about 70 wt. % lithium lanthanum zirconium oxide and 30 wt. % lithium indium chloride.

In some embodiments the ceramic material consists of 50 to 99 wt. % aluminium doped lithium lanthanum zirconium oxide and 1 to 50 wt. % lithium indium chloride, preferably 60 to 90 wt. % aluminium doped lithium lanthanum zirconium oxide and 10 to 40 wt. % lithium indium chloride, preferably 65 to 80 wt. % aluminium doped lithium lanthanum zirconium oxide and 20 to 35 wt. % lithium indium chloride, more preferably 68 to 75 wt. % aluminium doped lithium lanthanum zirconium oxide and 25 to 32 wt. % lithium indium chloride. In some embodiments the ceramic material consists of about 70 wt. % aluminium doped lithium lanthanum zirconium oxide and 30 wt. % lithium indium chloride.

In some embodiments the ceramic material consists of 50 to 99 wt. % tantalum doped lithium lanthanum zirconium oxide and 1 to 50 wt. % lithium indium chloride, preferably 60 to 90 wt. % tantalum doped lithium lanthanum zirconium oxide and 10 to 40 wt. % lithium indium chloride, preferably 65 to 80 wt. % tantalum doped lithium lanthanum zirconium oxide and 20 to 35 wt. % lithium indium chloride, more preferably 68 to 75 wt. % tantalum doped lithium lanthanum zirconium oxide and 25 to 32 wt. % lithium indium chloride. In some embodiments the ceramic material consists of about 70 wt. % tantalum doped lithium lanthanum zirconium oxide and 30 wt. % lithium indium chloride.

In some embodiments the ceramic material consists of 50 to 99 wt. % lithium lanthanum zirconium oxide and 1 to 50 wt. % lithium yttrium zirconium chloride, preferably 60 to 90 wt. % lithium lanthanum zirconium oxide and 10 to 40 wt. % lithium yttrium zirconium chloride, preferably 65 to 80 wt. % lithium lanthanum zirconium oxide and 20 to 35 wt. % lithium yttrium zirconium chloride, more preferably 68 to 75 wt. % lithium lanthanum zirconium oxide and 25 to 32 wt. % lithium yttrium zirconium chloride. In some embodiments the ceramic material consists of about 70 wt. % lithium lanthanum zirconium oxide and 30 wt. % lithium yttrium zirconium chloride.

In some embodiments the ceramic material consists of 50 to 99 wt. % aluminium doped lithium lanthanum zirconium oxide and 1 to 50 wt. % lithium yttrium zirconium chloride, preferably 60 to 90 wt. % aluminium doped lithium lanthanum zirconium oxide and 10 to 40 wt. % lithium yttrium zirconium chloride, preferably 65 to 80 wt. % aluminium doped lithium lanthanum zirconium oxide and 20 to 35 wt. % lithium yttrium zirconium chloride, more preferably 68 to 75 wt. % aluminium doped lithium lanthanum zirconium oxide and 25 to 32 wt. % lithium yttrium zirconium chloride. In some embodiments the ceramic material consists of about 70 wt. % aluminium doped lithium lanthanum zirconium oxide and 30 wt. % lithium yttrium zirconium chloride.

In some embodiments the ceramic material consists of 50 to 99 wt. % tantalum doped lithium lanthanum zirconium oxide and 1 to 50 wt. % lithium yttrium zirconium chloride, preferably 60 to 90 wt. % tantalum doped lithium lanthanum zirconium oxide and 10 to 40 wt. % lithium yttrium zirconium chloride, preferably 65 to 80 wt. % tantalum doped lithium lanthanum zirconium oxide and 20 to 35 wt. % lithium yttrium zirconium chloride, more preferably 68 to 75 wt. % tantalum doped lithium lanthanum zirconium oxide and 25 to 32 wt. % lithium yttrium zirconium chloride. In some embodiments the ceramic material consists of about 70 wt. % tantalum doped lithium lanthanum zirconium oxide and 30 wt. % lithium yttrium zirconium chloride.

In some embodiments the ceramic material consists of 50 to 99 wt. % lithium lanthanum zirconium oxide and 1 to 50 wt. % a lithium gallium fluoride-chloride mixed halide, preferably 60 to 90 wt. % lithium lanthanum zirconium oxide and 10 to 40 wt. % a lithium gallium fluoride-chloride mixed halide, preferably 65 to 80 wt. % lithium lanthanum zirconium oxide and 20 to 35 wt. % a lithium gallium fluoride-chloride mixed halide, more preferably 68 to 75 wt. % of lithium lanthanum zirconium oxide and 25 to 32 wt. % of a lithium gallium fluoride-chloride mixed halide. In some embodiments the ceramic material consists of about 70 wt. % lithium lanthanum zirconium oxide and 30 wt. % a lithium gallium fluoride-chloride mixed halide.

In some embodiments the ceramic material consists of 50 to 99 wt. % aluminium doped lithium lanthanum zirconium oxide and 1 to 50 wt. % a lithium gallium fluoride-chloride mixed halide, preferably 60 to 90 wt. % aluminium doped lithium lanthanum zirconium oxide and 10 to 40 wt. % a lithium gallium fluoride-chloride mixed halide, preferably 65 to 80 wt. % aluminium doped lithium lanthanum zirconium oxide and 20 to 35 wt. % a lithium gallium fluoride-chloride mixed halide, more preferably 68 to 75 wt. % aluminium doped lithium lanthanum zirconium oxide and 25 to 32 wt. % a lithium gallium fluoride-chloride mixed halide. In some embodiments the ceramic material consists of about 70 wt. % aluminium doped lithium lanthanum zirconium oxide and 30 wt. % a lithium gallium fluoride-chloride mixed halide.

In some embodiments the ceramic material consists of 50 to 99 wt. % tantalum doped lithium lanthanum zirconium oxide and 1 to 50 wt. % a lithium gallium fluoride-chloride mixed halide, preferably 60 to 90 wt. % tantalum doped lithium lanthanum zirconium oxide and 10 to 40 wt. % a lithium gallium fluoride-chloride mixed halide, preferably 65 to 80 wt. % tantalum doped lithium lanthanum zirconium oxide and 20 to 35 wt. % a lithium gallium fluoride-chloride mixed halide, more preferably 68 to 75 wt. % tantalum doped lithium lanthanum zirconium oxide and 25 to 32 wt. % a lithium gallium fluoride-chloride mixed halide. In some embodiments the ceramic material consists of about 70 wt. % tantalum doped lithium lanthanum zirconium oxide and 30 wt. % a lithium gallium fluoride-chloride mixed halide.

In some embodiments the ceramic material consists of 50 to 99 wt. % lithium aluminium titanium phosphate and 1 to 50 wt. % lithium yttrium zirconium chloride, preferably 60 to 90 wt. % lithium aluminium titanium phosphate and 10 to 40 wt. % lithium yttrium zirconium chloride, preferably 65 to 80 wt. % lithium aluminium titanium phosphate and 20 to 35 wt. % lithium yttrium zirconium chloride, more preferably 68 to 75 wt. % lithium aluminium titanium phosphate and 25 to 32 wt. % lithium yttrium zirconium chloride. In some embodiments the ceramic material consists of about 70 wt. % lithium aluminium titanium phosphate and 30 wt. % lithium yttrium zirconium chloride.

In some embodiments the ceramic material consists of 50 to 99 wt. % lithium aluminium titanium phosphate and 1 to 50 wt. % lithium indium chloride, preferably 60 to 90 wt. % lithium aluminium titanium phosphate and 10 to 40 wt. % lithium indium chloride, preferably 65 to 80 wt. % lithium aluminium titanium phosphate and 20 to 35 wt. % lithium indium chloride, more preferably 68 to 75 wt. % lithium aluminium titanium phosphate and 25 to 32 wt. % lithium indium chloride. In some embodiments the ceramic material consists of about 70 wt. % lithium aluminium titanium phosphate and 30 wt. % lithium indium chloride.

In some embodiments the ceramic material consists of 50 to 99 wt. % lithium aluminium titanium phosphate and 1 to 50 wt. % a lithium gallium fluoride-chloride mixed halide, preferably 60 to 90 wt. % lithium aluminium titanium phosphate and 10 to 40 wt. % a lithium gallium fluoride-chloride mixed halide, preferably 65 to 80 wt. % lithium aluminium titanium phosphate and 20 to 35 wt. % a lithium gallium fluoride-chloride mixed halide, more preferably 68 to 75 wt. % lithium aluminium titanium phosphate and 25 to 32 wt. % a lithium gallium fluoride-chloride mixed halide. In some embodiments the ceramic material consists of about 70 wt. % lithium aluminium titanium phosphate and 30 wt. % a lithium gallium fluoride-chloride mixed halide.

In some embodiments the ceramic material consists of 50 to 99 wt. % lithium yttrium zirconium phosphate and 1 to 50 wt. % lithium yttrium zirconium chloride, preferably 60 to 90 wt. % lithium yttrium zirconium phosphate and 10 to 40 wt. % lithium yttrium zirconium chloride, preferably 65 to 80 wt. % lithium yttrium zirconium phosphate and 20 to 35 wt. % lithium yttrium zirconium chloride, more preferably 68 to 75 wt. % lithium yttrium zirconium phosphate and 25 to 32 wt. % lithium yttrium zirconium chloride. In some embodiments the ceramic material consists of about 70 wt. % lithium yttrium zirconium phosphate and 30 wt. % lithium yttrium zirconium chloride.

In some embodiments the ceramic material consists of 50 to 99 wt. % lithium yttrium zirconium phosphate and 1 to 50 wt. % lithium indium chloride, preferably 60 to 90 wt. % lithium yttrium zirconium phosphate and 10 to 40 wt. % lithium indium chloride, preferably 65 to 80 wt. % lithium yttrium zirconium phosphate and 20 to 35 wt. % lithium indium chloride, more preferably 68 to 75 wt. % lithium yttrium zirconium phosphate and 25 to 32 wt. % lithium indium chloride. In some embodiments the ceramic material consists of about 70 wt. % lithium yttrium zirconium phosphate and 30 wt. % lithium indium chloride.

In some embodiments the ceramic material consists of 50 to 99 wt. % lithium yttrium zirconium phosphate and 1 to 50 wt. % a lithium gallium fluoride-chloride mixed halide, preferably 60 to 90 wt. % lithium yttrium zirconium phosphate and 10 to 40 wt. % a lithium gallium fluoride-chloride mixed halide, preferably 65 to 80 wt. % lithium yttrium zirconium phosphate and 20 to 35 wt. % a lithium gallium fluoride-chloride mixed halide, more preferably 68 to 75 wt. % lithium yttrium zirconium phosphate and 25 to 32 wt. % a lithium gallium fluoride-chloride mixed halide. In some embodiments the ceramic material consists of about 70 wt. % lithium yttrium zirconium phosphate and 30 wt. % a lithium gallium fluoride-chloride mixed halide.

Including these proportions of first and second lithium ion conductors provides a ceramic material which can be prepared by pressing at room temperature, but which achieves the appreciable conductivity required for a solid-state electrolyte material. It also permits the hygroscopic lithium metal halide to provide excellent air and moisture tolerance to the ceramic material, thus easing manufacture and mitigating a reduction in conductivity over time and/or exposure to air. Including this amount of second lithium ion conductor also makes the ceramic material low density, affording a high gravimetric energy density for electrochemical cells using the ceramic material as an electrolyte.

In some embodiments the ceramic material is a solid-state electrolyte for use in a lithium ion battery. The advantageous properties of the ceramic material described herein make it ideal for use as a solid-state electrolyte.

In some embodiments the ceramic material has a crystal density of from 3.5 to 5.0 g/cm³, preferably 3.8 to 4.8 g/cm³, preferably 4.0 to 4.7 g/cm³, preferably 4.2 to 4.6 g/cm³, preferably 4.3 to 4.5 g/cm³. In some embodiments the particulate of the first lithium ion conductor and/or the second lithium ion conductor have a crystal density of about 4.5 g/cm³.

The density of the ceramic material is relatively low. Therefore, electrochemical cells incorporating the ceramic material as a solid-state electrolyte offer a high gravimetric energy density, which is beneficial for portable applications and electric vehicles. This may provide a higher gravimetric energy density than, for example, electrochemical cells using a pure LLZO solid-state electrolyte, which has a bulk density of 5.07 g/cm³.

In some embodiments the first lithium ion conductor is of greater hardness than the second lithium ion conductor. In some embodiments the “hardness” denotes hardness measured on the “Moh scale”. In some embodiments the first lithium ion conductor has a greater Moh hardness than the second lithium ion conductor.

In some embodiments the first lithium ion conductor has a greater tensile stiffness than the second lithium ion conductor (where “tensile stiffness” denotes the Young's modulus). In some embodiments the Youngs modulus is measured by ISO 17561. In some embodiments the first lithium ion conductor has a greater Young's modulus than the second lithium ion conductor.

In some embodiments the first lithium ion conductor has a Young's modulus over 100 GPa. In some embodiments the first lithium ion conductor has a Young's modulus of from 100 to 200 GPa, preferably from 110 to 180 GPa, more preferably from 115 to 175 GPa. In some embodiments the first lithium ion conductor has a Young's modulus of from 100 to 130 GPa, preferably about 115 GPa. In some embodiments the first lithium ion conductor has a Young's modulus of from 165 to 185 GPa, preferably about 175 GPa.

In some embodiments the second lithium ion conductor has a Young's modulus of from 10 to 50 GPa, preferably from 15 to 40 GPa, more preferably from 20 to 30 GPa.

In some embodiments the first lithium ion conductor has a Young's modulus over 100 GPa, for example from 100 to 200 GPa, and the second lithium ion conductor has a Young's modulus of from 10 to 50 GPa.

By including a second lithium ion conductor which is softer and has a lower tensile stiffness than the first lithium ion conductor, it is thought that the second lithium ion conductor can act as a “flux” to mobilise particles of the harder first lithium ion conductor. As a result, the particles are sufficiently mobile for the composite ceramic material to be prepared at lower temperatures than traditional materials which require high temperature sintering.

### First Lithium Ion Conductor

A lithium ion conductor is a solid material which facilitates the flow of lithium ions.

In some embodiments the first lithium ion conductor is a ceramic lithium ion conductor.

In some embodiments, the first lithium ion conductor is an inorganic material selected from the Garnet family (such as LLZO), LISICON family (such as LSPO), thio-LISICON family (such as LGPS), NASICON family (such as LATP/LAGP/LYZP), perovskite family (such as LLTO/LLTP) and phosphide/sulfide glass ceramics.

In some embodiments, the first lithium ion conductor is an inorganic material selected from the Garnet family (such as LLZO), LISICON family (such as LSPO), thio-LISICON family (such as LGPS), NASICON family (such as LATP/LAGP/LYZP), and perovskite family (such as LLTO/LLTP).

In some embodiments the first lithium ion conductor is an inorganic material selected from the Garnet family and the NASICON family.

In some embodiments, the first lithium ion conductor is an inorganic material selected from lithium lanthanum zirconium oxide (LLZO), lithium silicate phosphorous oxide (LSPO), lithium germanium phosphorous sulphide (LGPS), lithium aluminium titanium phosphate (LATP), lithium aluminium germanium phosphate (LAGP), lithium yttrium zirconium oxide (LYZO), lithium yttrium zirconium phosphate (LYZP), lithium lanthanum titanium oxide (LLTO) and lithium lanthanum titanium phosphate (LLTP).

In some embodiments, the first lithium ion conductor is an inorganic material selected from lithium lanthanum zirconium oxide (LLZO), lithium aluminium titanium phosphate (LATP), lithium aluminium germanium phosphate (LAGP), lithium yttrium zirconium oxide (LYZO), lithium yttrium zirconium phosphate (LYZP) and lithium lanthanum titanium oxide (LLTO).

In some embodiments the first lithium ion conductor is lithium lanthanum zirconium oxide (LLZO), lithium aluminium titanium phosphate (LATP), lithium yttrium zirconium phosphate (LYZP) or a combination thereof.

In some embodiments the first lithium ion conductor is an inorganic material which is an oxide or a phosphate. In some embodiment the first lithium ion conductor is a lithium metal oxide or lithium metal phosphate (wherein “lithium metal oxide” denotes an inorganic material including lithium, one or more metals different from lithium and oxygen, and wherein “lithium metal phosphate” denotes an inorganic material including lithium, one or more metals different from lithium and phosphate).

In some embodiments the first lithium ion conductor is a lithium metal oxide or lithium metal phosphate, wherein the one or metals are selected from transition metals, rare earth metals, group 13 metals and group 14 metals. In some embodiments the one or metals are selected from group 3, group 4, group 13 and group 14 metals. In some embodiments the one or metals are selected from Sc, Y, Lu, La, Ti, Zr, Hf, Ce, Al, Ga, In, Tl, Ge, Sn and Pb. In some embodiments, the one or more metals are selected from Y, La, Ti, Zr, Al and Ge. In some embodiments the one or more metals are selected from Y, La, Ti, Zr, and Al.

In some embodiments the first lithium ion conductor comprises a dopant element. In some embodiments the first lithium ion conductor does not comprise a dopant element.

In some embodiments the dopant element is selected from Al, Ga, Zn, Be, Mg and Co. In some embodiments the dopant element is Al.

The described first lithium ion conductors (such as LLZO, LATP and LYZP) tend to be less expensive than lithium metal halides, so including a portion of these in the ceramic material reduces the cost of the ceramic material. The described first lithium ion conductors are also tolerant to lithium metal electrodes, so it is thought that including a portion of these has the potential to provide excellent compatibility of the ceramic material with lithium metal electrodes.

In some embodiments the first lithium ion conductor comprises a mixture of two or more materials.

In some embodiment the first lithium ion conductor is LLZO.

In some embodiments the LLZO does not comprise a dopant element. In some embodiments the LLZO material has a formula Li₇La₃Zr₂O₁₂.

In some embodiments the LLZO has a garnet-type structure or a structure close to the garnet-type.

In some embodiments the first lithium ion conductor is aluminium doped lithium lanthanum zirconium oxide (Al-LLZO).

The inclusion of a dopant element increases the conductivity of the first lithium ion conductor. In particular, aluminium doped LLZO (Al-LLZO) may have a higher lithium ion conductivity than undoped LLZO, so may contribute to the excellent conductivity of the ceramic material. The presence of small quantities of one or more dopant elements may help to provide a more chemically stable structure and/or tailored grain boundary effects. Alternatively, the dopant may more preferably be tantalum instead of aluminium (i.e. tantalum-doped LLZO (Ta-LLZO)). Tantalum may provide further improvements in the lithium ion conductivity compared to aluminium. In other words, in some embodiments the first lithium ion conductor is tantalum doped lithium lanthanum zirconium oxide (Ta-LLZO).

In some embodiments, the LLZO material has a composition according to formula I:

Li_{7-w}AₐLa_{3-b}B_{b}Zr_{2-c}C_{c}O_{12-z}X_{z} (I)
wherein A is selected from Al, Ga, Zn, Be, Mg and Co;
B is selected from Ca, Ba, Sr, Rb, Y;
C is selected from Hf, Co, Si, W, Ta, Nb, Sb, Sn, Mg, Mn, Cr, Mo, Pt, Pd, Rh, Ir, Ca and Tc;
X is selected from Cl, Br and F;
0≤w≤1.5;
0≤a≤0.5;
0≤b≤0.6;
0≤c≤0.6; and
0≤z≤1;
wherein w, a, b, c and z are chosen to provide an overall composition which is charge-balanced.

In some embodiments, A is Al. In some embodiments Al-LLZO has a formula Li_{5.5}Al_{0.5}La₃Zr₂O₁₂. In some embodiment Al-LLZO has a formula Li_{6.25}Al_{0.25}La₃Zr₂O₁₂. The LLZO material may contain excess lithium which resides outside the LLZO phase, for example as lithium oxide (Li₂O). Thus in some embodiments the LLZO material contains an LLZO phase which is represented by the formula Li_{6.25}Al_{0.25}La₃Zr₂O₁₂, and a Li₂O phase. The molar ratio of (Li_{6.25}Al_{0.25}La₃Zr₂O₁₂) to (Li₂O) in the material may be from about 1:0.1 to 1:0.5.

Expressed as percentage by weight based on the total weight of the LLZO material, in some embodiments the aluminium content of the LLZO material is from 0 to 1.5 wt %, for example from 0 to 1.2 wt %, from 0.5 to 1.5 wt %, from 0.5 to 1.2 wt %, from 0.5 to 1.0 wt %, or about 0.8 wt %.

In some embodiments the Al-LLZO has a formula Li_{6.25}Al_{0.25}La₃Zr₂O₁₂.

In some embodiments the first lithium ion conductor is LATP.

In some embodiments the LATP does not comprise an additional dopant element.

In some embodiments the LATP material has a composition according to formula II:

Li_{d}AlₑTi_{f}(PO₄)₃ (II)
wherein 1.2≤d≤1.5;
0≤e≤0.5; and
1.5≤f≤1.8;
wherein d, e and f are chosen to provide an overall composition which is charge-balanced.

In some embodiments, 1.3≤d≤1.4; 0.3≤e≤0.4; and 1.6≤f≤1.7; wherein d, e and f are chosen to provide an overall composition which is charge-balanced.

In some embodiments the LATP has the formula Li_{1.3}Al_{0.3}Ti_{1.7}(PO₄)₃. In other embodiments, LATP has the formula Li_{1.4}Al_{0.4}Ti_{1.6}(PO₄)₃.

In some embodiments the LATP has a NASICON-type structure or a structure close to the NASICON-type.

In some embodiments the LATP comprises an additional dopant element. In some embodiments the dopant element is selected from Al, Ga, Zn, Be, Mg and Co. In some embodiments the dopant element is Al.

In some embodiments the first lithium ion conductor is LYZP.

In some embodiments the LYZP does not comprise a dopant element. In some embodiments the LYZP has the formula Li₁₊ₓYₓZr₂₋ₓ(PO₄)₃, where x is from 0 to 0.25. In some embodiments x is from 0.05 to 0.20, preferably 0.10 to 0.15. In some embodiments x is 0.15.

In some embodiments the LYZP has a NASICON-type structure or a structure close to the NASICON-type.

In some embodiments the LYZP comprises a dopant element. In some embodiments the dopant element is selected from Ca, Yb, Al, Ga, Zn, Be, Mg and Co. In some embodiments the dopant element is selected from Ca and Yb. In some embodiments the dopant element is a group 2 metal, preferably Ca. In some embodiments the dopant element is Yb.

In some embodiments the first lithium ion conductor has a conductivity of from 1×10⁻⁵ to 1×10⁻³ S/cm, preferably from 5×10⁻⁵ to 5×10⁻⁴ S/cm, more preferably from 8×10⁻⁵ to 2×10⁻⁴ S/cm. In some embodiments the first lithium ion conductor has a conductivity of about 1×10⁻⁴ S/cm, where the conductivity is the lithium ion conductivity for a sintered ceramic body of the first lithium ion conductor.

Conductivity is measurable by electrochemical impedance spectroscopy, for example using a Biologic VSP potentiostat, using a pellet of material having a diameter of 8 mm and a thickness between 0.5 and 1 mm, using a 50 mV perturbation voltage applied in the frequency range of 1 MHz to 0.1 mHz, at a temperature of 25° C.

In some embodiments the conductivity of the first lithium ion conductor is lower than the second lithium ion conductor.

In some embodiments the first lithium ion conductor has a crystal density of from 2.8 to 5.2 g/cm³, preferably 2.9 to 5.1 g/cm³. In some embodiments the first lithium ion conductor has a crystal density of about 5.1 g/cm³. In some embodiments the first lithium ion conductor has a crystal density of about 2.8 to 3.2 g/cm³, preferably about 2.9 to 3.1 g/cm³.

### Second Lithium Ion Conductor

The second lithium ion conductor is a lithium ion conductor different from the first lithium ion conductor. The second lithium ion conductor is a lithium metal halide.

A lithium ion conductor is a solid material which facilitates the flow of lithium ions.

A lithium metal halide is an inorganic material comprising lithium, one or more metals different from lithium, and a halide.

In some embodiments the one or more metals are selected from rare earth metals, transition metals, and group 13, 14 and 15 metals. In some embodiments the one or metals are selected from Ti, Y, Zr, V, Cr, Mn, Fe, Cd, Er and In.

In some embodiments the one or metals are selected from group 3, group 4 and group 13 metals. In some embodiments the one or more metals are selected from Sc, Y, Ti, Zr, Ga, and In. In some embodiments the one or more metals are selected from Y, Zr, Ga and In.

In some embodiments the second lithium ion conductor is a lithium metal chloride, a lithium metal bromide or a lithium metal fluoride-chloride mixed halide, preferably a lithium metal chloride or a lithium metal fluoride-chloride mixed halide, more preferably a lithium metal fluoride-chloride mixed halide.

In some embodiments the lithium metal halide is a ternary or quaternary halide, preferably a ternary or quaternary chloride, bromide or fluoride-chloride mixed halide, more preferably a ternary or quaternary chloride or fluoride-chloride mixed halide, even more preferably a ternary or quaternary fluoride-chloride mixed halide. In some embodiments the lithium metal halide is a ternary halide, preferably a ternary chloride, bromide or fluoride-chloride mixed halide, more preferably a ternary chloride or fluoride-chloride mixed halide, even more preferably a ternary fluoride-chloride mixed halide.

In some embodiments the lithium metal halide has a composition according to formula III:

Li₃₋ₘM¹₁₋ₘM²ₘX₆ (III)
wherein 0≤m≤0.75;
M¹ and M² are each independently selected from rare earth metals, transition metals, group 13 metals, group 14 metals and group 15 metals;
X is selected from Cl, Br and I.

In some embodiments m is 0 to 0.5.

In some embodiments M¹ and M² are metals having an oxidation state of ±2, ±3 or ±4. In some embodiments M¹ is selected from In, Y, Zr, Er and Fe. In some embodiments M² is Zr.

In some embodiments X is Cl or Br, preferably Cl.

In some embodiments the lithium metal halide has a composition according to formula IIIa:

Li₃₋ₘM¹₁₋ₘM²ₘX₆ (IIIa)
wherein 0≤m≤0.75;
M¹ and M² are each independently selected from rare earth metals, transition metals, group 13 metals, group 14 metals and group 15 metals;
X is selected from F, Cl, Br and I, and combinations thereof.

In some embodiments m is 0 to 0.5.

In some embodiments M¹ and M² are metals having an oxidation state of ±2, ±3 or ±4. In some embodiments M¹ is selected from In, Y, Zr, Er and Fe. In some embodiments M² is Zr.

In some embodiments X is F, CI or a combination thereof, preferably a combination of F and Cl, more preferably wherein F and CI are equimolar.

In some embodiments, the lithium metal halide preferably comprises, and more preferably consists of, a lithium gallium fluoride-chloride mixed halide, wherein the lithium gallium fluoride-chloride mixed halide is defined by the following formula (IV):

[LiCl]ₐ[GaF₃]_{b} (IV),
wherein the molar ratio a:b is from 4:1 to 1:1, preferably from 3:1 to 2:1, more preferably about 3:1.

In some embodiments the lithium metal halide has a monoclinic-type structure or a structure close to the monoclinic-type, a orthorhombic-type structure or a structure close to the orthorhombic-type, or a trigonal-type structure or a structure close to trigonal-type.

In some embodiments the structure comprises a cubic or hexagonal close packed halide sublattice. In some embodiments the monoclinic-type structure or a structure close to the monoclinic-type comprises a cubic close packed halide sublattice. In some embodiments the orthorhombic-type structure or the structure close to the orthorhombic-type, or the trigonal-type structure or the structure close to trigonal-type comprise a hexagonal close packed halide sublattice.

In some embodiments the lithium metal halide structure is anisotropic.

In some embodiments the lithium metal halide comprises a dopant element. In some embodiments the lithium metal halide does not comprise a dopant element.

In some embodiments the dopant element is a group 2 metal. In some embodiments the dopant element is Be, Mg, Ca or Sr. In some embodiments the dopant element is Mg. In some embodiments the dopant element is Ca.

In some embodiments the second lithium ion conductor is lithium indium chloride (LIC), lithium yttrium chloride (LYC), lithium zirconium chloride (LZC), lithium yttrium zirconium chloride (LYZC), lithium zirconium iron chloride, lithium indium zirconium chloride a lithium gallium fluoride-chloride mixed halide (LGFC), or a combination thereof.

In some embodiments the second lithium ion conductor is LIC. In some embodiments LIC has the formula Li₃InCl₆. In some embodiments LIC has a monoclinic-type structure or a structure close to the monoclinic-type.

In some embodiments the second lithium ion conductor is LYC. In some embodiments LYC has the formula Li₃YCl₆.

In some embodiments the second lithium ion conductor is LZC. In some embodiments LZC has the formula Li₂ZrCl₆.

In some embodiments the second lithium ion conductor is LYZC. In some embodiments LYZC has the formula Li_{2.5}Y_{0.5}Zr_{0.5}Cl₆. In some embodiments LYZC has a trigonal-type structure or a structure close to trigonal-type.

In some embodiment the second lithium ion conductor is lithium zirconium iron chloride. In some embodiments the lithium zirconium iron chloride has the formula Li_{2.25}Zr_{0.75}Fe_{0.25}Cl₆.

In some embodiment the second lithium ion conductor is lithium indium zirconium chloride. In some embodiments the lithium indium zirconium chloride has the formula Li₃₋ₓIn₁₋ₓZrₓCl₆ where x is from 0 to 0.5.

In some embodiments, the second lithium ion conductor is LGFC. It should be understood that LGFC is typically amorphous. Accordingly, any embodiments in which the crystal structure (of the lithium metal halide) is defined do not typically include embodiments in which LGFC is the lithium metal halide.

The second lithium ion conductors are highly conductive, soft, low density and may be hygroscopic lithium metal halides. The softness of the lithium metal halides may permit the ceramic material to be produced by pressing at room temperature, thus reducing manufacturing costs and improving scalability. The high conductivity may result in a ceramic material having an appreciable conductivity even after only pressing at room temperature. The low density of second lithium ion conductor may mean the resulting ceramic material has a low density, and thus provides a high gravimetric energy density for electrochemical cells. The hygroscopicity of certain lithium metal halides, such as LIC, means that it readily absorbs water, thus reducing the effect of moisture an air on the first lithium ion conductor. The water can be desorbed by heating to 200° C. under vacuum, thus regenerating the conductivity of the material.

In some embodiments the second lithium ion conductor has a conductivity of from 1×10⁻⁴ to 1×10⁻² S/cm, preferably from 5×10⁻⁴ to 5×10⁻³ S/cm, more preferably from 8×10⁻⁴ to 2×10⁻³ S/cm. In some embodiments the second lithium ion conductor has a conductivity of about 1×10⁻³ S/cm, where the lithium ion conductivity is for a sintered ceramic body of the second lithium ion conductor.

In some embodiments, conductivity is measured by electrochemical impedance spectroscopy. In some embodiments, conductivity is measured by electrochemical impedance spectroscopy, using a Biologic VSP potentiostat, using a pellet of material having a diameter of 8 mm and a thickness between 0.5 and 1 mm, using a 50 mV perturbation voltage applied in the frequency range of 1 MHz to 0.1 mHz, at a temperature of 25° C.

In some embodiments the conductivity of the second lithium ion conductor is higher than the first lithium ion conductor.

In some embodiments the second lithium ion conductor has a crystal density of from 2.0 to 3.0 g/cm³, preferably 2.2 to 2.8 g/cm³, preferably 2.3 to 2.7 g/cm³, preferably 2.4 to 2.6 g/cm³.

### Impurities

The ceramic material may contain less than 1500 ppm of trace impurities by weight. In some embodiments the first lithium ion conductor may contain less than 1500 ppm of trace impurities by weight. In some embodiments, any further elements (other than the elements listed in the formula or dopant elements) are present in a total amount of less than 2000 ppm by weight, for example less than 1500 ppm, less than 1200 ppm or less than 1000 ppm. In some embodiments the total amount of any one element present as a trace impurity is less than 500 ppm by weight.

In some embodiments the LLZO contain less than 1500 ppm trace impurity, including the elements Fe, Ti, Ca, Cr, Cl, P and F. In other words, if the LLZO material contains one or more of these elements, the total amount may be less than 1500 ppm. In some embodiments, the total amount of any one element present as a trace impurity is less than 500 ppm by weight. In some embodiments, the total amount of any one element selected from Fe, Ti, Ca, Cr, Cl, P and F present as a trace impurity is less than 500 ppm.

In some embodiments the LATP contain less than 1500 ppm trace impurity, including the elements Fe, Ti, Ca, Cr, Cl, and F. In other words, if the LATP material contains one or more of these elements, the total amount may be less than 1500 ppm. In some embodiments, the total amount of any one element present as a trace impurity is less than 500 ppm by weight. In some embodiments, the total amount of any one element selected from Fe, Ti, Ca, Cr, CI and F present as a trace impurity is less than 500 ppm.

In some embodiments the LYZP contain less than 1500 ppm trace impurity, including the elements Fe, Ti, Ca, Cr, Cl, and F. In other words, if the LYZP material contains one or more of these elements, the total amount may be less than 1500 ppm. In some embodiments, the total amount of any one element present as a trace impurity is less than 500 ppm by weight. In some embodiments, the total amount of any one element selected from Fe, Ti, Ca, Cr, CI and F present as a trace impurity is less than 500 ppm.

### Method of Preparing a Ceramic Material

In a second aspect of the invention there is provided a method of preparing a ceramic material for a solid-state electrolyte, comprising the following steps:
a) mixing a particulate of a first lithium ion conductor and a particulate of a second lithium ion conductor to form a mixture, wherein the second lithium ion conductor is different to the first lithium ion conductor and is a lithium metal halide;
b) pressing the mixture to form the ceramic material.

In a third aspect of the invention there is provided a ceramic material obtained or obtainable by the method described in the second aspect of the invention.

In some embodiments the ceramic material is a solid-state electrolyte for use in a lithium ion battery.

The first lithium ion conductor and second lithium ion conductor are mixed as particulates.

In some embodiments the mixing step is preceded by a milling step, wherein the first lithium ion conductor and/or the second lithium ion conductor are milled to provide a particulate of the first lithium ion conductor and/or the second lithium ion conductor. The milling step reduces the particle size of the particulate. The method of milling is not particularly limited and may include dry milling or wet (slurry) milling. The milling may be achieved by any suitable milling method such as ball milling, attritor milling, high shear mixing.

In some embodiments the method of milling includes dry milling. In some embodiments the method of milling includes slurry milling. In some embodiments, the slurry milling uses a slurry formed with an organic solvent, preferably an alkane solvent.

The step a) comprises mixing a particulate of a first lithium ion conductor and a particulate of a second lithium ion conductor to form a mixture. Herein, “mixing” refers to combining two or more materials to form a homogeneous mixture.

In some embodiments step a) comprises mixing under an inert atmosphere. In some embodiments, the inert atmosphere comprises one or more of N₂ and Ar. In some embodiments, the inert atmosphere comprises N₂. In some embodiments, the inert atmosphere comprises Ar.

In some embodiments, the mixing is performed in air which has been filtered to contain less than 0.1 ppm total hydrocarbons.

In some embodiments, the mixing is performed in dry air (where “dry” denotes a moisture content of less than 10 ppm by weight, for example less than 5 ppm or less than 1 ppm). In some embodiments, the mixing is performed in CO₂-free air (where “CO₂-free” denotes air with a CO₂ content of less than 5 ppm by weight, for example less than 4 ppm, less than 2 ppm or less than 1 ppm).

In some embodiments step a) comprises mixing by pestle and mortar. In some embodiments the pestle and mortar is an agate pestle and mortar.

In some embodiments step a) comprises mixing by resonance acoustic mixing.

In some embodiments step a) comprises liquid phase mixing.

The step b) comprises pressing the mixture to form a ceramic material. Herein, “pressing” refers to applying a pressure to the mixture.

In some embodiments step b) comprises pressing at a pressure of greater than 1000 kg/cm², preferably greater than 1500 kg/cm², more preferably greater than 3000 kg/cm². In some embodiments step b) comprises pressing at a pressure of from 1000 to 5000 kg/cm², preferably from 1500 to 4000 kg/cm², preferably from 3000 to 4000 kg/cm², more preferably from 3500 to 4000 kg/cm². In some embodiments step b) comprises pressing at a pressure of about 3800 kg/cm².

In some embodiments step b) comprises pressing the mixture for between 10 seconds and 10 minutes, preferably between 30 seconds and 5 minutes, preferably between 45 seconds and 2 minutes, more preferably about 1 minute.

In some embodiments step b) comprises pressing the mixture at a first pressure for a first period of time, and then pressing the mixture at a second pressure for a second period of time.

In some embodiments the first pressure is greater than the second pressure. In some embodiments the first pressure is over 2000 kg/cm², preferably over 3000 kg/cm², preferably over 3500 kg/cm². In some embodiments the first pressure is about 3800 kg/cm². In some embodiments the second pressure is less than 3000 kg/cm², preferably less than 2000 kg/cm². In some embodiments the second pressure is about 1500 kg/cm².

In some embodiments the first period of time is shorter than the second period of time. In some embodiments the first period of time is between 10 seconds and 10 minutes, preferably between 30 seconds and 5 minutes, preferably between 45 seconds and 2 minutes, more preferably about 1 minute.

In some embodiments the second period of time is between 1 minute and 60 minutes, preferably between 10 minutes and 50 minutes, preferably between 20 minutes and 40 minutes, more preferably about 30 minutes.

A suitable machine for pressing the mixture is a Sphere ASC-T solid-state battery testing apparatus. Another suitable machine for pressing the mixture may be a hydraulic press.

In some embodiments step b) comprises pressing the mixture at a temperature of less than 800° C., preferably less than 600° C., preferably less than 400° C., preferably less than 200° C., more preferably less than 100° C. In some embodiments step b) comprises pressing the mixture at a temperature of from 0 to 800° C., preferably from 0 to 400° C., preferably from 0 to 200° C., preferably from 0 to 100° C. In some embodiments step b) comprises pressing the mixture at room temperature (where “room temperature” denotes a temperature of about 25° C.).

In some embodiments the method comprises a further step of milling the ceramic material produced in step b) to reduce the particle size of the final product. The method of milling is not particularly limited, and may include dry milling or wet (slurry) milling. The milling may be achieved by any suitable milling method such as ball milling, attritor milling, high shear mixing. In some embodiments the method of milling includes dry milling. In some embodiments the method of milling includes slurry milling. In some embodiments, the slurry milling uses a slurry formed with an organic solvent, preferably an alkane solvent.

In some embodiments the ceramic material produced in step b) does not need to be milled further and can be used directly as a solid-state electrolyte.

In some embodiments the method of preparing a ceramic material is carried out at a temperature of less than 800° C., preferably less than 600° C., preferably less than 400° C., preferably less than 200° C., more preferably less than 100° C. In some embodiments the method of preparing a ceramic material is carried out at room temperature (where “room temperature” denotes a temperature of about 25° C.).

In some embodiments the method of preparing a ceramic material does not include a step of heating the ceramic material to a high temperature (e.g. sintering), such as above 800° C. In some embodiments, in the method of preparing a ceramic material the ceramic material is not heated to a temperature above 800° C., preferably not above 600° C., preferably not above 400° C., preferably not above 200° C., more preferably not above 100° C. In some embodiments in the method of preparing a ceramic material the ceramic material is not heated.

### Regeneration Step

In some embodiments the second aspect of the invention further comprises a regeneration step, the regeneration step comprising heating the ceramic material under vacuum to release absorbed water and/or carbon dioxide (where “under vacuum” denotes an absolute pressure of between 0.1 and 30000 Pa, preferably 1 to 10000 Pa, preferably 10 to 5000 Pa, preferably 50 to 2000 Pa, preferably 100 to 1000 Pa more preferably about 500 Pa).

In some embodiments the regeneration step comprises heating the ceramic material in “dry” air (where “dry” denotes a moisture content of less than 10 ppm by weight, preferably less than 5 ppm by weight, more preferably less than 1 ppm by weight).

In some embodiments the regeneration step comprises heating the ceramic material in “CO₂-free” air (where “CO₂ free” denotes air with a CO₂ content of less than 5 ppm by weight, preferably less than 3 ppm by weight, more preferably less than 1 ppm by weight).

In some embodiments the regeneration step comprises heating the ceramic material at a temperature less than 500° C., preferably less than 400° C., more preferably less than 300° C. In some embodiments the regeneration step comprises heating the ceramic material at a temperature between 150° C. and 250° C., preferably between 170° C. and 230° C., more preferably between 190° C. and 210° C. In some embodiments the regeneration step comprises heating the ceramic material at a temperature of about 200° C.

In some embodiments the regeneration step comprises heating the ceramic material for 1 to 24 hours, preferably from 4 to 18 hours, preferably from 8 to 16 hours, more preferably from 10 to 14 hours. In some embodiments the regeneration step comprises heating the ceramic material for about 12 hours.

The absorption of moisture into certain lithium metal halides, such as LIC, is reversible so the ceramic material can be regenerated after exposure to air and moisture. Without wishing to be bound by theory, it is thought that by heating to a moderate temperature under vacuum, the water is desorbed from the lithium metal halide component of the ceramic material, which regenerates the ceramic material and the conductivity is restored. The ceramic material may be manufactured in the presence of air and moisture, because the ceramic can be regenerated (for example, as described above) prior to incorporation into a final product. This reduces the cost of manufacture and makes production easier to scale up to a commercially viable level.

### Solid-State Electrolyte

The ceramic material may be an electrolyte, preferably a solid-state electrolyte. The solid-state electrolyte refers to a material which is solid at room temperature, for example at 25° C.

The solid-state electrolyte material is a lithium ion conductor that transfers charge-carrying ions, such as lithium, within an electrochemical cell between a cathode and an anode.

In some embodiments, the solid-state electrolyte for a lithium ion battery, preferably a secondary lithium ion battery.

The ceramic material may also find use as an ion conductor in applications selected from batteries (e.g. lithium ion secondary batteries), electrochromic systems, accumulators (e.g. supercapacitors), chemical sensors (e.g. gas sensors) and thermoelectric converters.

The shape of the solid-state electrolyte may be a thin, plate like structure.

### Electrochemical Cell

The present invention also provides an electrochemical cell comprising a cathode, an anode, and a solid-state electrolyte of the invention.

In some embodiments the solid-state electrolyte is interposed between the cathode and anode. In some embodiments the solid-state electrolyte is in direct contact with the cathode and anode. In some embodiments, the electrochemical cell includes a solid-state electrolyte without any liquid electrolyte.

A cathode comprising any suitable cathode active material may be used. An anode comprising any suitable anode active material may be used. The person skilled in the art is aware of suitable cathode and anode materials.

The electrochemical cell may also comprise terminals for connection to an external device or an external power supply.

The electrochemical cell may be a lithium ion cell, preferably a secondary lithium ion cell. The electrochemical cell may comprise a lithium metal electrode.

The ceramic material has good compatibility with lithium metal electrodes, for example compared to pure lithium metal halide solid-state electrolytes such as LIC.

### Battery

The present invention also provides a battery comprising one or more electrochemical cells of the invention. In some embodiments, the battery is a secondary lithium ion battery.

Where there is a plurality of cells, these may be provided in series or parallel.

A battery of the invention may be provided in an electronic device. In some embodiments, the electronic device is a mobile phone, a tablet, a laptop or a power tool. In some embodiments the battery is provided in an electric vehicle.

### Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### EXAMPLES

The following examples are provided to further illustrate the present invention and are not intended to limit the scope of the invention.

### Experimental Methods

The materials used in the synthesis methods described herein were prepared as described herein, or were used as received from commercial suppliers without any heat treatment or other treatment prior to mixing.

The Al-LLZO (Li_{6.25}Al_{0.25}La₃Zr₂O₁₂) was prepared by using LiOH (32.74 g), La(OH)₃ (67.22 g), Zr(OH)₄ (36.94 g), Al(OH)₃ (2.62 g) and 5 wt. % excess lithium (7 g). The oxide content of each regent was determined by calcining each of LiOH, La(OH)₃, Zr(OH)₄ and Al(OH)₃ at 1100° C. Using the oxide content, the appropriate amount of hydroxide reagent required for the synthesis of Li_{6.25}Al_{0.25}La₃Zr₂O₁₂ was calculated. The use of an oxide content to calculate the amount of reagent required (by discounting additional moisture content) is well known to the person skilled in the art.

The reagents were added to a 2.5 L ceramic milling pot followed by 152 g of ethanol. The product was briefly mixed with a plastic stirring rod to make a slurry. Alumina beads (500 ml total, 300 ml of 10 mm beads and 200 ml of 15 mm beads) were added and the pot was sealed. The pot was rolled on speed setting 5 (of 10) for 3 hours on a roller mill. After 3 hours the product was recovered by passing the mixture through a 2 mm sieve and the beads were rinsed with ethanol. The pot was scraped out and this was combined with the main product and air dried overnight in a fume hood to remove the ethanol. A white powder was obtained and the beads were sieved out. The product was fired at 1050° C. for 6 hours in a closed MgO tray and transferred to a glove box before it cooled below 150° C. Powder XRD confirmed the product to be cubic Al-LLZO with a phase purity of 95.7%.

The LATP (Li_{1.4}Al_{0.4}Ti_{1.6}(PO₄)₃) was prepared by adding LiH₂PO₄ (19.04 g), Al₂O₃ (3.20 g), TiO₂(17.06 g) and (NH₄)H₂PO₄ (24.08 g) to a 1.25 L ceramic milling pot followed by 64 g of ethanol (solids:solvent ratio 1:1 w/w). The product was briefly mixed with a plastic stirring rod to make a slurry. Alumina beads (500 ml total, 300 ml of 10 mm beads and 200 ml of 15 mm beads) were added and the pot was sealed. The pot was rolled on speed setting 4 (out of 10) for 3 hours on a roller mill. The product was isolated from the beads by passing the mixture through a 2 mm sieve. The pot was scraped out and this was combined with the main product and air dried overnight in a fume hood to remove the ethanol. A white powder was obtained. The powder was calcined at 700° C. for 4 hours and the light grey solid was reground and calcined at 900° C. for 6 hours in a covered silica tray to obtain a loosely fused white solid. This was milled in a high energy ball mill in portions for 1 minute. The product was recovered through a 200 micron sieve. Li_{1.4}Al_{0.4}Ti_{1.6}(PO₄)₃ was reported as the main product by XRD.

The LIC was prepared according to the method described in Li, X. et al. Agnew. Chem. Int. Ed. 2019, 58, 1647-1632.

The LYZC was prepared according to the method described in Jung, Y. S. et al. Adv. Energy Mater. 2021, 11, 2003190.

The alumina was provided by Alfa Aesar; CAS No. 1344⁻²⁸-1 (102 g/mol); APS=20 nm, 99%; dried at 200° C. overnight.

Mixing was carried out using an agate pestle and mortar in a glove box under an Ar atmosphere.

Cold pressing was carried out using a Sphere ASC-T solid-state battery testing equipment.

Conductivity was measured by electrochemical impedance spectroscopy, using a Biologic VSP potentiostat. The pellet of material was 8 mm in diameter with a thickness between 0.5 and 1 mm. A 50 mV perturbation voltage was applied in the frequency range of 1 MHz to 0.1 mHz. The measurement was carried out at 25° C.

### Example 1—Synthesis of Ceramic Material with Different LLZO:LIC Ratios

Al-LLZO and LIC powders were mixed in a pestle and mortar for 5 minutes under an argon atmosphere, in the proportions provided in Table 1. Comparative Example 1 was prepared in the same way, but using only Al-LLZO.

Pressing Method a (3800 kg/cm²)

80 mg of the resultant mixture was loaded into the Sphere ASC-T solid-state battery testing apparatus in a glove box under an argon atmosphere. The Sphere ASC-T was then removed from the glove box. The mixture was then pressed at 25° C. and a pressure of 3800 kg/cm² for 1 minute to form 80 mg of a ceramic material. The pressure was then reduced to 1500 kg/cm² for about 30 minutes, during which time the material was allowed to reach thermal equilibrium and then conductivity measurements were taken.

Pressing Method B (1500 kg/cm²)

80 mg of the resultant mixture was loaded into the Sphere ASC-T solid-state battery testing apparatus in a glove box under an argon atmosphere. The Sphere ASC-T was then removed from the glove box. The mixture was then pressed at 25° C. and a pressure of 1500 kg/cm² to form 80 mg of a ceramic material. The pressure was maintained for about 30 minutes, during which time the material was allowed to reach thermal equilibrium and then conductivity measurements were taken.

TABLE 1
Compositions of Example 1

| | Al-LLZO (wt. %) | LIC (wt. %) |
|---|---|---|
| Example 1-A | 95 | 5 |
| Example 1-B | 90 | 10 |
| Example 1-C | 85 | 15 |
| Example 1-D | 80 | 20 |
| Example 1-E | 75 | 25 |
| Example 1-F | 70 | 30 |
| Comparative | 100 | 0 |
| Example 1 | | |

### Example 2—Conductivity of Ceramic Material with Different LLZO:LIC Ratios

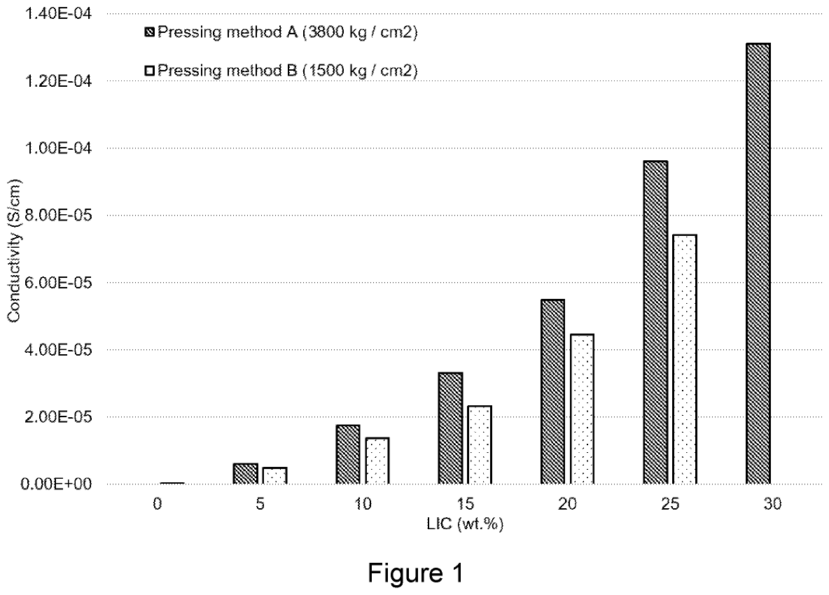

The conductivities of the ceramic materials prepared in Example 1 using pressing methods A and B were measured using electrochemical impedance spectroscopy. The conductivity was measured once the material reached thermal equilibrium under a pressure of 1500 kg/cm². The results are provided in Table 2. These are also provided in FIG. 1. In FIG. 1, the bars on the left-hand side at each LIC wt. % relate to pressing method A, whereas the bars on the right-hand side at each LIC wt. % relate to pressing method B.

TABLE 2
Conductivity of ceramics prepared in Example 1

| | |
|---|---|
| Pressing method A | Pressing method B |
| (3800 kg/cm²) | (1500 kg/cm²) |

Conductivity (S/cm)

| | | |
|---|---|---|
| Example 1-A | 6.11 × 10⁻⁶ | 4.78 × 10⁻⁶ |
| Example 1-B | 1.76 × 10⁻⁵ | 1.38 × 10⁻⁵ |
| Example 1-C | 3.32 × 10⁻⁵ | 2.32 × 10⁻⁵ |
| Example 1-D | 5.48 × 10⁻⁵ | 4.45 × 10⁻⁵ |
| Example 1-E | 9.61 × 10⁻⁵ | 7.41 × 10⁻⁵ |
| Example 1-F | 1.31 × 10⁻⁴ | — |
| Comparative | — | 3.28 × 10⁻⁷ |
| Example 1 | | |

The conductivity of Examples 1-A to 1-F, which include a portion of LIC, is significantly higher than Comparative Example 1 which does not include any LIC. Increasing the amount of LIC from Examples 1-A to 1-F increases the conductivity of the ceramic material. Cold pressing Al-LLZO without the addition of LIC results in poor conductivity compared to cold pressing Al-LZZO with a portion of LIC.

This shows that the ceramic material of the invention produced by cold pressing has comparable conductivity to that of Al-LLZO produced by more energy-intensive high-temperature sintering.

This also shows that increasing the content of LIC results in an increase in the conductivity of the ceramic material.

The conductivity of the Examples pressed using method A (with a maximum pressure of 3800 kg/cm²) is slightly higher than Examples pressed using method B (with a maximum pressure of 1500 kg/cm²). This shows that pressing at higher pressure results in higher lithium ion conductivity.

However, even the materials pressed using method B have a much greater lithium ion conductivity than Comparative Example 1. This shows that the ceramic material of the invention can still achieve an appreciable lithium ion conductivity even when pressed at a lower pressure.

### Example 3—Synthesis of Ceramic Materials with Different Components

Ceramic materials were prepared using the same method as described in Example 1, using pressing method B, and the components and proportions provided in Table 3.

TABLE 3
Compositions of Example 3

| | First lithium ion | | Second lithium ion | |
|---|---|---|---|---|
| | conductor | | conductor | |
| | | Amount | | Amount |
| | Type | (wt. %) | Type | (wt. %) |
| Example 3-A | Al-LLZO | 70 | LYZC | 30 |
| Example 3-B | LATP | 70 | LYZC | 30 |
| Example 3-C | Al-LLZO | 50 | LYZC | 50 |
| Comparative Example 3-A | Alumina | 20 | LIC | 80 |
| Comparative Example 3-B | Alumna | 40 | LIC | 60 |
| Comparative Example 3-C | Alumina | 70 | LIC | 30 |

Example 3-A and Example 3-B were characterised using Raman spectroscopy.

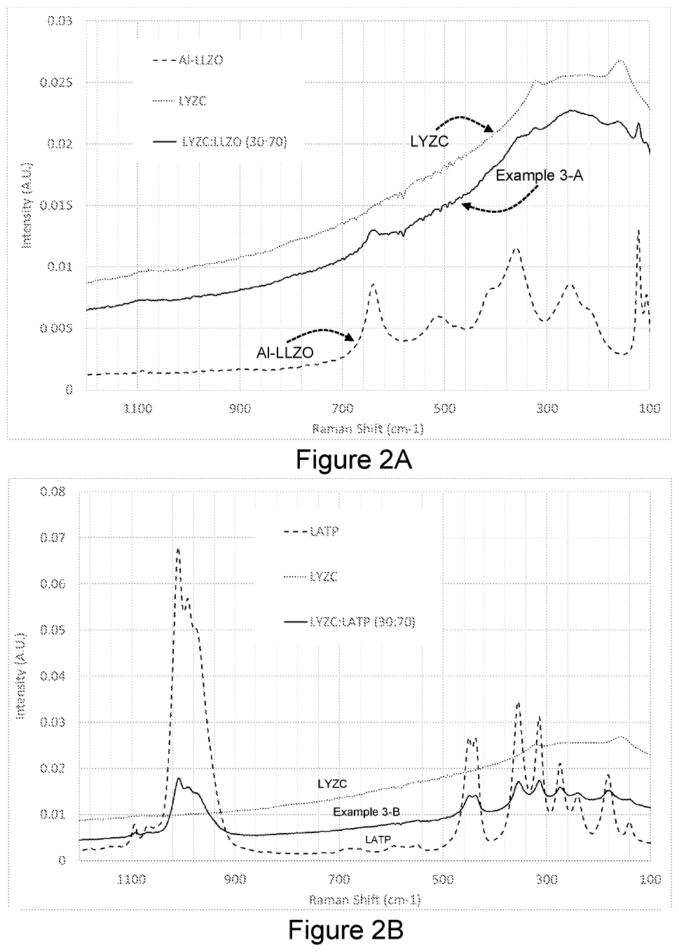

FIG. 2A shows the Raman spectra of Example 3-A overlayed with those of pure Al-LLZO and pure LYZC respectively. The bottom dashed line shows the spectra for Al-LLZO and the top dotted line shows the spectra for LYZC. It can be seen that the middle solid line (Example 3-A) includes the peaks for both Al-LLZO and LYZC, so both phases are still present.

FIG. 2B shows the Raman spectra of Example 3-B overlayed with those of pure LATP and pure LYZC respectively. The bottom dashed line at 700 cm⁻¹ is the spectra for LATP. The top dotted line at 700 cm⁻¹ is LYZC. The middle solid line at 700 cm⁻¹ shows the spectra of Example 3-B, which includes the features of both LATP and LYZC-however peak overlap limits the visibility of the LYZC peaks.

Examples 3-A and Example 3-B were also characterised using focused ion beam-scanning electron microscopy (FIB-SEM).

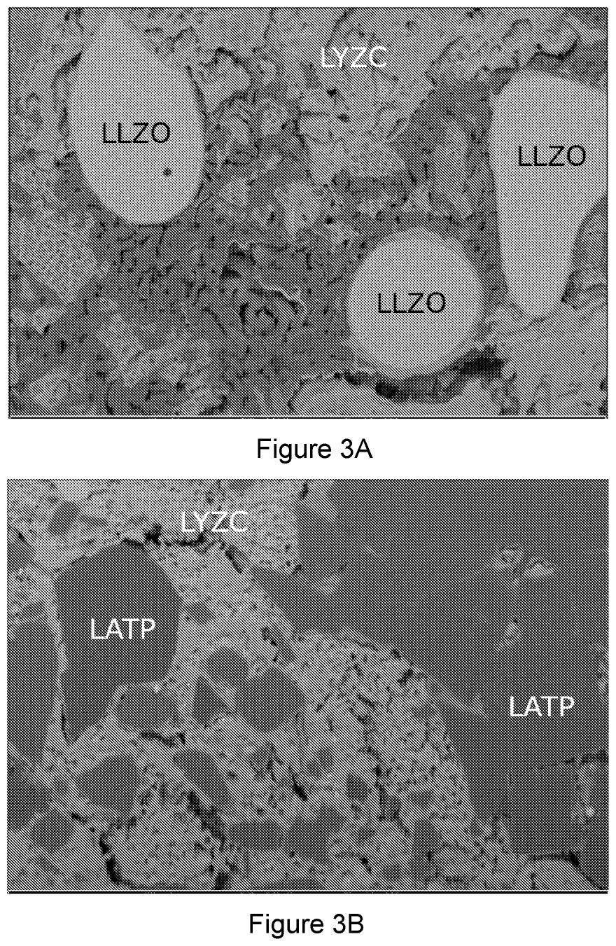

FIG. 3A shows a FIB-SEM of Example 3-A. It can be seen that both the Al-LLZO and the LYZC phases are present in Example 3-A.

FIG. 3B shows a FIB-SEM of Example 3-B. It can be seen that both the LATP and LYZC phases are present in Example 3-B.

### Example 4—Conductivity of Ceramic Material with Different Components

The conductivity of the Examples 3-A, 3-B and 3-C and Comparative Examples 3-A, 3-B and 3-C prepared in Example 3 were measured using electrochemical impedance spectroscopy. The results are provided in Table 4.

TABLE 4
Conductivity of ceramics prepared in Example 3

| | Conductivity (S/cm) |
|---|---|
| Example 3-A | 2.5 × 10⁻⁴ |
| Example 3-B | 1.5 × 10⁻⁴ |
| Example 3-C | 6.4 × 10⁻⁴ |
| Comparative Example 3-A | 9.5 × 10⁻⁵ |
| Comparative Example 3-B | 3.2 × 10⁻⁶ |
| Comparative Example 3-C | not measurable |

The conductivity of Examples 3-A and 3-B, which include 30 wt. % of LYZC with different first lithium ion conductor materials are all in a good range, most having a conductivity of greater than 1×10⁻⁴ S/cm. The conductivity of Example 3-C, which includes 50 wt. % LYZC has an excellent lithium ion conductivity of 6.4×10⁻⁴. This is due to the higher proportion of lithium metal halide.

The ceramic materials produced by cold pressing thus have a comparable lithium ion conductivity compared to pure Al-LLZO or LATP produced by high temperature sintering. For example, pure LATP prepared via high temperature sintering has a conductivity of 8.24×10⁻⁴ S/cm. This is comparable to the conductivity of Examples 3-A to 3-C prepared by cold pressing. The ceramic materials thus have a suitable conductivity for use as solid-state electrolytes.

The conductivity of Comparative Example 3-A, 3-B and 3-C which include non-conductive alumina in place of the first lithium ion conductor is lower than Examples 1-A to 1-F and Examples 1-A to 3-C, which include Al-LLZO or LATP as the first lithium ion conductor. Comparative Example 3-C which includes a similar amount of LIC as Example 1-F and Examples 3-A to 3-C (30 wt. % LIC) displayed a conductivity which was so low that it was not measurable. Only comparative Examples 3-A and 3-B (having 50 and 80 wt. % LIC respectively) had a measurable conductivity, although this was still poor compared to the ceramic materials including a first lithium ion conductor.

This shows that the excellent conductivity properties can be attributed to the inclusion of both the first and second lithium ion conductors, and not only the second lithium ion conductor.

### Example 5—Synthesis of LGFC

The following describes the synthesis of LiCl—GaF₃ (LGFC) in a 3:1 molar ratio, i.e. the synthesis of (LiCl)₃—GaF₃.

LiCl (0.356 g, 0.0084 mol) was hand grinded with GaF₃ (0.350 g, 0.0028 mol) in a pestle and mortar for 10 minutes inside an argon filled glove box. No further treatment was carried out.

### Example 6—Synthesis of Ceramic Materials Comprising LGFC

Composite ceramic materials were prepared in 0.5 g batches by hand grinding LATP and the LGFC prepared in Example 5 in various weight ratios in a pestle and mortar for 10 minutes inside an argon filled glove box. No further treatment was carried out.

A reference material was also prepared containing 30% LGFC—70% Al₂O₃, in which 0.15 g of LGFC was ground with 0.35 g of Al₂O₃ powder.

The components and the proportions thereof are provided in Table 5.

TABLE 5
Compositions of Example 6

| | First lithium ion | | Second lithium ion | |
|---|---|---|---|---|
| | conductor | | conductor | |
| | | Amount | | Amount |
| | Type | (wt. %) | Type | (wt. %) |
| Example 6-A | LATP | 95 | LGFC | 5 |
| Example 6-B | LATP | 90 | LGFC | 10 |
| Example 6-C | LATP | 80 | LGFC | 20 |
| Example 6-D | LATP | 70 | LGFC | 30 |
| Comparative Example 6-A | Alumina | 70 | LGFC | 30 |

Pressing Method C (1500 kg/cm²)

80 mg of each resultant mixture was loaded into the Sphere ASC-T solid-state battery testing apparatus in a glove box under an argon atmosphere. The Sphere ASC-T was then removed from the glove box. The mixture was then pressed at 25° C. under a pressure of 1500 kg/cm² to form 80 mg of a ceramic material. The temperature was increased to 130° C. and maintained for 10 minutes. After cooling to 25° C. the conductivity measurements were taken.

### Example 7—Conductivity of Ceramic Materials Comprising LGFC

The conductivity of the Examples 6-A, 6-B, 6-C and 6-D and the Comparative Example 6-A were measured using electrochemical impedance spectroscopy. The results are provided in Table 6.

TABLE 6
Conductivity of ceramics prepared in Example 6

| | Conductivity (S/cm) |
|---|---|
| Example 6-A | 3.2 × 10⁻⁴ |
| Example 6-B | 9.7 × 10⁻⁴ |
| Example 6-C | 2.2 × 10⁻³ |
| Example 6-D | 2.5 × 10⁻³ |
| Comparative Example 6-A | 2.4 × 10⁻⁴ |

These data show that (1) both LATP and LGFC contribute to the overall ionic conductivity and (2) the incorporation of LGFC provides a far better flux than LYZC or LIC, for example. In particular, when LATP is substituted for an equal amount of alumina (which does not conduct Li ions) in Comparative Example 6-A, then the conductivity drops by an order of magnitude. Moreover, comparing these ceramics with the ceramics comprising other second lithium ion conductors, for example, Example 3-B above (30% LYZC-70% LATP) has a conductivity of 1.5×10⁻⁴ S/cm, which is almost 17 times less than the same composition using LGFC (Example 6-D). This may be due to the extremely soft and pliable nature of LGFC, first reported by Jung, S. K. et al. in ACS Energy Lett. 2021, 6, 2006-2015, for example.

In other words, the ceramic materials comprising LGFC as a second lithium ion conductor can surprisingly and advantageously exhibit even greater improvements in lithium ion conductivity.

1. A ceramic material for a solid-state electrolyte, the ceramic material comprising:
a first lithium ion conductor; and
a second lithium ion conductor different from the first lithium ion conductor and which is a lithium metal halide.

2. The ceramic material of claim 1, wherein the first lithium ion conductor is a lithium metal oxide or lithium metal phosphate,
wherein the lithium metal oxide comprises lithium, one or more metals different from lithium and oxygen, and
wherein the lithium metal phosphate comprises lithium, one or more metals different from lithium and phosphate.

3. The ceramic material of claim 2, wherein the one or metals are selected from transition metals, rare earth metals, group 13 metals and group 14 metals, preferably selected from group 3, group 4, group 13 and group 14 metals, more preferably selected from Sc, Y, Lu, La, Ti, Zr, Hf, Ce, Al, Ga, In, Tl, Ge, Sn and Pb.

4. The ceramic material of any preceding claim wherein the first lithium ion conductor is an inorganic material selected from the Garnet family and the NASICON family.

5. The ceramic material of any preceding claim wherein the first lithium ion conductor is lithium lanthanum zirconium oxide, lithium aluminium titanium phosphate, lithium yttrium zirconium phosphate, or a combination thereof.

6. The ceramic material of any preceding claim, wherein the first lithium ion conductor comprises a dopant element, preferably aluminium or tantalum.

7. The ceramic material of claim 6, wherein the first lithium ion conductor is aluminium doped lithium lanthanum zirconium oxide or tantalum doped lithium lanthanum zirconium oxide.

8. The ceramic material of any preceding claim, wherein the lithium metal halide comprises lithium, one or more metals different from lithium, and a halide
wherein the one or metals are selected from rare earth metals, transition metals, and group 13, 14 and 15 metals, preferably selected from Ti, Y, Zr, V, Cr, Mn, Fe, Cd, Er and In, more preferably selected from Y, Zr and In.

9. The ceramic material of any preceding claim, wherein the second lithium ion conductor has a monoclinic-type structure or a structure close to the monoclinic-type, a orthorhombic-type structure or a structure close to the orthorhombic-type, or a trigonal-type structure or a structure close to the trigonal-type.

10. The ceramic material of any preceding claim, wherein the second lithium ion conductor is lithium indium chloride, lithium yttrium zirconium chloride, lithium zirconium chloride, lithium yttrium zirconium chloride, lithium zirconium iron chloride, lithium indium zirconium chloride, a lithium gallium fluoride-chloride mixed halide or a combination thereof,
preferably lithium indium chloride, lithium yttrium zirconium chloride, a lithium gallium fluoride-chloride mixed halide or a combination thereof.

11. The ceramic material of any preceding claim, wherein the lithium metal halide comprises a lithium gallium fluoride-chloride mixed halide, wherein the lithium gallium fluoride-chloride mixed halide is defined by the following formula (IV):
[LiCl]ₐ[GaF₃]_{b} (IV),
wherein the molar ratio a:b is from 4:1 to 1:1, preferably from 3:1 to 2:1, more preferably about 3:1.

12. The ceramic material of any preceding claim, wherein the ceramic material comprises 50 to 99 wt. % of the first lithium ion conductor, preferably 60 to 90 wt. %, more preferably 65 to 80 wt. %.

13. The ceramic material of any preceding claim, wherein the ceramic material comprises 1 to 50 wt. % of the second lithium ion conductor, preferably 10 to 40 wt. %, more preferably 20 to 35 wt. %.

14. The ceramic material of any one of claims 1 to 11, wherein the ceramic material comprises about 70 wt. % of the first lithium ion conductor and about 30 wt. % of the second lithium ion conductor.

15. The ceramic material of any preceding claim, wherein the first lithium ion conductor has a conductivity of about 1×10⁻⁴ S/cm.

16. The ceramic material of any preceding claim, wherein the second lithium ion conductor has a conductivity of about 1×10⁻³ S/cm.

17. The ceramic material of any preceding claim, wherein the conductivity of the second lithium ion conductor is higher than the first lithium ion conductor.

18. A method of preparing a ceramic material for a solid-state electrolyte, comprising the following steps:
a) mixing a particulate of a first lithium ion conductor and a particulate of a second lithium ion conductor to form a mixture, wherein the second lithium ion conductor is different to the first lithium ion conductor and is a lithium metal halide;
b) pressing the mixture to form the ceramic material.

19. The method of claim 18, wherein step a) comprises mixing under an inert atmosphere, preferably under argon.

20. The method of claim 18 or 19, wherein step b) comprises pressing at a pressure of from 1000 to 5000 kg/cm², preferably from 1500 to 4000 kg/cm², more preferably from 3000 to 4000 kg/cm².

21. The method of any one of claims 18 to 20, wherein step b) comprises pressing the mixture at a temperature of less than 800° C., preferably less than 200° C., more preferably at room temperature.

22. The method of any one of claims 18 to 21, further comprising a regeneration step, the regeneration step comprising heating the ceramic material under vacuum to release absorbed water and/or carbon dioxide.

23. The method of claim 22, wherein the regeneration step comprises heating the ceramic material at a temperature between 150° C. and 250° C., preferably between 170° C. and 230° C., more preferably between 190° C. and 210° C.

24. A ceramic material obtained or obtainable by the method of any one of claims 18 to 23.

25. The ceramic material of any one of claims 1 to 17, or claim 24, wherein the ceramic material is a solid-state electrolyte for use in a lithium ion battery.

26. A solid-state electrolyte comprising the ceramic material of any one of claims 1 to 17, or claim 24.

27. An electrochemical cell comprising a cathode, an anode, and the solid-state electrolyte according to claim 26.
